(19) United States
(12) Patent Application Publication
(10) Pub. No.: US 2011/0012814 A1
(43) Pub. Date: Jan. 20, 2011

(54) Adjustable Attachment for Attaching Head-Mounted Display to Eyeglasses-Type Frame

(75) Inventor: Mitsugi TANAKA, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, Nagoya-shi (JP)

(21) Appl. No.: 12/830,866

(22) Filed: Jul. 6, 2010

(30) Foreign Application Priority Data
Jul. 15, 2009 (JP) 2009-166597

(51) Int. Cl. G09G 5/00

(52) U.S. Cl. 345/8

(57) ABSTRACT

An attachment device for attaching a monocular head-mounted display device (HMD) to an eyeglasses-type frame worn on a head of a viewer is disclosed. The attachment device is configured to include: a main body detachably attached to the eyeglasses-type frame; a movable member disposed between the main body and the display device, angularly and linearly displaceable relative to the main body; and a mode changer configured to change between a small-rotation-angle mode and a large-rotation-angle mode, in a mechanically synchronized manner with a relative linear displacement of the movable member to the main body. The small-rotation-angle mode enables the movable member to be angularly displaced through an angle smaller than 180 degrees, while the large-rotation-angle mode enables the movable member to be angularly displaced through an angle equal to or larger than 180 degrees.

### CROSS-REFERENCE TO RELATED APPLICATIONS

The present application is based on and claims the benefit of priority from Japanese Patent Application No. 2009-166597 filed 15 Jul., 2009, the content of which is incorporated herein by reference in its entirety.

### BACKGROUND OF THE INVENTION

1. Field of the Invention

The invention relates generally to an attachment device for attaching a monocular head-mounted display device (HMD) to an eyeglasses-type frame worn on a viewer's head, and more particularly to techniques for enhancing the ease-to-use of the attachment device.

2. Description of the Related Art

As one type of a display device for optically displaying an image, there is known a monocular display device for projecting imaging light representative of an image to a viewer's one eye, to thereby display the image to the viewer.

The types of such a monocular display device includes a see-through type that enables a viewer to view a displayed image with a real world outside scene in front of the viewer's one eye, and a closed type that enables a viewer to view only a displayed image.

A see-through display device can be used in a situation in which, while viewing a real outside world scene, a viewer views a reference image or information image, for example, at the periphery of a field-of-view (or a field-of-interest) for the viewer, wherein the reference image is to be viewed by the viewer for reference to information which can help the viewer in working in a real outside world. The see-through display device can be also used in an alternative situation in which the viewer views only a displayed image, for example, in the middle of a field-of-view of the viewer.

Display devices for optically displaying an image can be also classified into different types of image formation techniques.

One type of a display device is configured, as disclosed in, for example, Japanese Patent Application Publication No. 2008-176096, to project a light beam emitted from a light source, onto a viewer's retina, and scan the projected light beam on the retina, to thereby form surface light for imaging which enables the viewer to view a displayed image.

An alternative type of a display device is configured to spatially modulate surface light emitted from a light source, using a spatial light modulator such as an LCD, on a per-pixel basis, to thereby form surface light for imaging which enables the viewer to view a displayed image.

### BRIEF SUMMARY OF THE INVENTION

A monocular head-mounted display device (hereinafter, abbreviated as “HMD”) is required to allow a viewer to adjust the position and orientation of the HMD relative to the viewer's one eye, that is, one of the viewer's eyes which is used for viewing an image, in order to accommodate various settings, such as the position of the viewer's one eye, the position of a displayed image relative to the viewer's one eye, the viewer's posture during viewing, etc.

More specifically, the HMD is required, for example, to allow the viewer to adjust the relative position of the HMD to the viewer's one eye, in an up-and-down (i.e., vertical) direction and a right-and-left direction, and the relative orientation of the HMD to the viewer's one eye in a vertical plane. The HMD may be additionally required to allow the viewer to adjust the relative position of the HMD to the viewer's one eye, in a back-and-forth direction.

For enabling such geometrical adjustment (alignment) of the HMD, an attachment device is used for attaching the HMD to an eyeglasses-type frame, and the attachment device is designed to achieve the geometrical adjustment of the HMD.

The viewer may desire to view a displayed image by the HMD, with the viewer's right eye or left eye.

In addition, it is desirable for the same HMD and the same attachment device to enable the viewer to view a displayed mage whether the viewer selects the right eye or the left eye for viewing the image, which enhances the ease-to-use of these HMD and attachment device.

In other words, it is desirable for the HMD and the attachment device to allow the viewer to switch the same HMD and the same attachment device between a position enabling image viewing with the right eye and a position enabling image viewing with the left eye, and therefore, to enhance the ease of switchability between right and left positions.

As will be evident from the above, a monocular HMD and an attachment device are required to provide both the geometrical adjustment function and enhanced switchability between right and left positions.

However, in particular when the HMD emits imaging light along an optical pathway in a horizontal plane, if the HMD, combined with the attachment device, is switched from, for example, a position suitable for the right eye to a position suitable for the left eye, then the displayed image is 180-degree inverted, with the attachment device inverted, unintendedly.

For this reason, traditionally, the viewer, for switching the position of the HMD, has to take the trouble to remove from the attachment device, one of the components of the attachment device which, if the position of the HMD is switched together with the attachment device between right and left positions, will be inverted, and attach the removed component to the attachment device again, with the removed component inverted.

As a result, traditionally, the viewer, in an attempt to switch the position of the HMD between right and left positions, feels cumbersome, and also there is a risk of components of the attachment device to drop, be damaged, or be deformed.

In view of the foregoing, it would be desirable to enhance the ease-to-use of an attachment device for attaching a monocular HMD to an eyeglasses-type frame worn on a viewer's head.

According to some aspects of the invention, an attachment device for attaching a monocular head-mounted display device (HMD) to an eyeglasses-type frame worn on a head of a viewer is provided.

The attachment device comprises:
a main body detachably attached to the eyeglasses-type frame;
a movable member disposed between the main body and the display device, angularly and linearly displaceable relative to the main body; and
a mode changer configured to change between a small-rotation-angle mode and a large-rotation-angle mode, in a mechanically synchronized manner with a relative linear displacement of the movable member to the main body, wherein the small-rotation-angle mode enables the movable member to be angularly displaced through an angle smaller than 180 degrees, while the large-rotation-angle mode enables the movable member to be angularly displaced through an angle equal to or larger than 180 degrees.

It is noted here that, as used in this specification, the singular form “a,” “an,” and “the” include plural reference unless the context clearly dictates otherwise. It is also noted that the terms “comprising,” “including,” and “having” can be used interchangeably.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a top plan view illustrating an attachment device according to an illustrative embodiment of the invention, combined with a head-mounted display device (hereinafter, abbreviated as “HMD”) and an eyeglasses-type frame, with these elements mounted on a viewer's head;

FIG. 2 is a block diagram and an optical path diagram conceptually illustrating configurations of a control unit and a display unit within the HMD depicted in FIG. 1;

FIG. 3 is a perspective view illustrating the attachment device depicted in FIG. 1, combined with the display unit and the eyeglasses-type frame of the HMD, with these elements mounted on the viewer's head;

FIG. 4 is a perspective view illustrating the attachment device depicted in FIG. 1, when it is mounted on the display unit of the HMD and it is separate from the eyeglasses-type frame;

FIG. 5A is a perspective view illustrating the attachment device depicted in FIG. 4, when it is mounted on the display unit, and FIG. 5B is a perspective view illustrating only the attachment device;

FIG. 6A is a perspective view illustrating a main body depicted in FIG. 5B, FIG. 6B is a perspective view illustrating a movable member depicted in FIG. 5B, and FIG. 6C is a perspective view illustrating a retainer for retaining the movable member so as not to remove from the main body;

FIG. 7A is a front view illustrating the main body depicted in FIG. 6A, FIG. 7B is a side view illustrating the main body, FIG. 7C is a cross section taken along a line C-C in FIG. 7A, and FIG. 7D is a cross section taken along a line D-D in FIG. 7B;

FIG. 8A is a front view illustrating a linearly-displaceable member depicted in FIG. 6A, FIG. 8B is a side view illustrating the linearly-displaceable member, FIG. 8C is a back view illustrating the linearly-displaceable member, and FIG. 8D is a cross section taken along a line D-D in FIG. 8A;

FIG. 9A is a front view illustrating the movable member depicted in FIG. 6B, FIG. 9B is a top plan view illustrating the movable member, FIG. 9C is a side view illustrating the movable member, and FIG. 9D is a cross section taken along a line D-D in FIG. 9A;

FIG. 10A is a front view illustrating the retainer depicted in FIG. 6C, FIG. 10B is a side view illustrating the retainer, and FIG. 10C is a back view illustrating the retainer;

FIG. 11A is a cross section obtained by cutting the attachment device depicted in FIG. 6B, by a horizontal plane passing through a rotation axis CL3 of the movable member, and FIG. 11B is a cross section obtained by cutting the attachment device, by a vertical plane passing through the rotation axis CL3;

FIG. 12 is a front view illustrating the main body depicted in FIG. 6A and the movable member depicted in FIG. 6B, when they are assembled and the movable member is in an upright position;

FIG. 13 is a front view illustrating the main body depicted in FIG. 6A and the movable member depicted in FIG. 6B, when they are assembled and the movable member is inclined at a maximum angle from the upright position;

FIG. 14 is a front view illustrating the main body depicted in FIG. 6A and the movable member depicted in FIG. 6B, when they are assembled and the movable member is at a lowermost position; and

FIG. 15 is a front view illustrating the main body depicted in FIG. 6A and the movable member depicted in FIG. 6B, when they are assembled, the movable member is at the lowermost position, and the movable member is rotated 90 degrees from the upright position.

### DETAILED DESCRIPTION OF THE INVENTION

According to the invention, the following modes are provided as illustrative embodiments of the invention.

(1) An HMD attachment device for attaching a head-mounted display device (HMD) to an eyeglasses-type frame worn on a head of a viewer, wherein the HMD is mounted on the head of the viewer for projecting imaging light representative of an image onto one eye of the viewer, to thereby display the image to the viewer, the HMD attachment device comprising:
a main body detachably attached to the eyeglasses-type frame;
a movable member disposed between the main body and the display device, wherein the movable member is angularly displaceable about a rotation axis, relative to the main body, the movable member is linearly displaceable relative to the main body, and the movable member is held at a selected one of possible angular positions and a selected one of possible linear positions; and
a mode changer configured to selectively change a mode in which the movable member is angularly displaced relative to the main body, between a small-rotation-angle mode which enables the movable member to be angularly displaced through an angle smaller than 180 degrees, and a large-rotation-angle mode which enables the movable member to be angularly displaced through an angle equal to or larger than 180 degrees, wherein the mode change is in a mechanically synchronized manner with a relative linear displacement of the movable member to the main body.

(2) The HMD attachment device according to mode (1), wherein the movable member is selectively switched by the viewer, between a first region and a second region which are in a linear array along a direction of the relative linear displacement, and the mode changer selects the small-rotation-angle mode when the movable member is located in the first region, and selects the large-rotation-angle mode when the movable member is located in the second region.

(3) The HMD attachment device according to mode (1), wherein the small-rotation-angle mode is a mode in which the relative angular displacement of the movable member is limited, while the large-rotation-angle mode is a mode in which the relative angular displacement of the movable member is not limited.

(4) The HMD attachment device according to mode (1), wherein the rotation axis is linearly displaced with the movable member, in synchronization with a linear displacement of the movable member relative to the main body.

(5) The HMD attachment device according to mode (4), further comprising a linearly-displaceable member which is linearly displaceable relative to the main body, in a direction parallel to a centerline of the main body, and which is held at a selected on of possible linear positions,
wherein the movable member is attached to the linearly-displaceable member, such that the movable member is not linearly displaceable relative to the linearly-displaceable member, and such that the movable member is angularly displaceable about the rotation axis, relative to the linearly-displaceable member, to thereby cause the rotation axis to be linearly displaced with the linearly-displaceable member.

(6) The HMD attachment device according to mode (1), wherein the movable member allows the viewer to adjust a position of the display device in an up-and-down direction, relative to the one eye of the viewer, by the viewer's manipulation of linearly displacing the display device relative to the main body, with the HMD attachment device mounted on the eyeglasses-type frame, and
the movable member further allows the viewer to adjust an angular position of the display device within in a vertical plane, relative to the one eye of the viewer, by the viewer's manipulation of angularly displacing the display device relative to the main body.

(7) The HMD attachment device according to mode (1), wherein the movable member is attached to the display device via a position adjuster,
the position adjuster is configured to allow the viewer to linearly displace the display device relative to the main body, in a direction crossing the centerline of the main body, and
the position adjuster is further configured to retain the display device at a selected one of the possible linear positions.

(8) The HMD attachment device according to mode (7), wherein the position adjuster allows the viewer to adjust a position of the display device in a right-and-left direction, relative to the one eye of the viewer, by the viewer's manipulation of linearly displacing the display device relative to the main body, with the HMD attachment device mounted on the eyeglasses-type frame.

(9) The HMD attachment device according to mode (1), wherein the mode changer is configured to include:
a first engagement portion formed in the main body, wherein the first engagement portion has a first engagement surface which extends along a centerline of the main body, locations are arrayed on and along the first engagement surface, the locations have respective lateral distances from the centerline of the main body, and the lateral distances vary at least in part between corresponding respective linear positions arrayed on and along the centerline of the main body; and
a second engagement portion formed in the main body for allowing for mechanical engagement with the first engagement portion, wherein the second engagement portion has a second engagement surface which extends generally along at least a part of a circle about a center point identified by viewing the rotation axis in a direction thereof, locations are arrayed on and along the second engagement surface, the locations have respective radial distances from the center point, and the radial distances vary at least in part between corresponding respective angular positions arrayed on and along the second engagement surface.

(10) The HMD attachment device according to mode (1), wherein the mode changer is configured to include:
a groove formed in the main body so as to extend along a centerline of the main body, wherein the groove has a pair of facing side-wall surfaces which are symmetric with respect to the centerline of the main body, the pair of side-wall surfaces are spaced wall-to-wall distances apart at respective longitudinal positions arrayed on and along the centerline of the main body, and the wall-to-wall distances vary at least in part between corresponding respective longitudinal positions, and
an engagement protrusion formed in the main body so as to have a center axis which is coaxial with the rotation axis, wherein the engagement protrusion has a cross section taken on a plane perpendicular to the center axis of the engagement protrusion, the cross section has an outer circumference generally in the form of a circle about the center axis, the outer circumference is mechanically engaged in part with the pair of side-wall surfaces of the groove, locations are arrayed on and along the outer circumference, the locations have corresponding respective radial distances from the center axis, and the radial distances vary at least in part between corresponding respective angular positions.

(11) The HMD attachment device according to mode (10), wherein the groove has first and second zones which are in a linear array along the centerline of the main body and which located at respective different positions,
the wall-to-wall distances within the first zone are smaller than those within the second zone,
the outer circumference has a pair of first arc segments, and a plurality of straight segments each of which extends from one of both ends of a corresponding one of the pair of first arc segments and which is tangential to the corresponding first arc segment at the one end,
the pair of first arc segments, when the engagement protrusion is located between the pair of side-wall surfaces within the first zone, is allowed to be brought into an engagement state in which the pair of first arc segments are mechanically engaged with the pair of side-wall surfaces within the first zone, and is allowed to be slidably rotated relative to the pair of side-wall surfaces, in the engagement state,
the straight segments, upon entry from a state in which the pair of first arc segments are mechanically engaged with the pair of side-wall surfaces within the first zone, into a state in which the engagement protrusion is slidably rotated relative to the straight segments, in a direction allowing the pair of first arc segments to move toward the straight segments, is brought into abutment with the pair of side-wall surfaces within the first zone, to thereby allow the engagement protrusion to act as a stop which blocks the engagement protrusion from further slide rotation in the same direction, to thereby achieve the small-rotation-angle mode of the movable member, and
the straight segments, when the engagement protrusion is located between the pair of side-wall surfaces within the second zone, does not act as the stop, to thereby achieve the large-rotation-angle mode of the movable member.

(12) The HMD attachment device according to mode (11), wherein the outer circumference further includes a pair of second arc segments on a circle having a diameter larger than a diameter of a circle on which the pair of first arc segments, and
the pair of second arc segments, when the engagement protrusion is located between the pair of side-wall surfaces within the second zone, is mechanically engaged with the pair of side-wall surfaces within the second zone, and is slidably rotated relative to the pair of side-wall surfaces, to thereby achieve the large-rotation-angle mode of the movable member.

(13) The HMD attachment device according to mode (1), wherein the main body has a shape symmetric with regard to a centerline of the main body.

(14) The HMD attachment device according to mode (1), wherein the display device is configured to project the imaging light onto the one eye of the viewer, along an optical pathway extending generally on and along a horizontal plane.

Several presently preferred embodiments of the invention will be described in more detail by reference to the drawings in which like numerals are used to indicate like elements throughout.

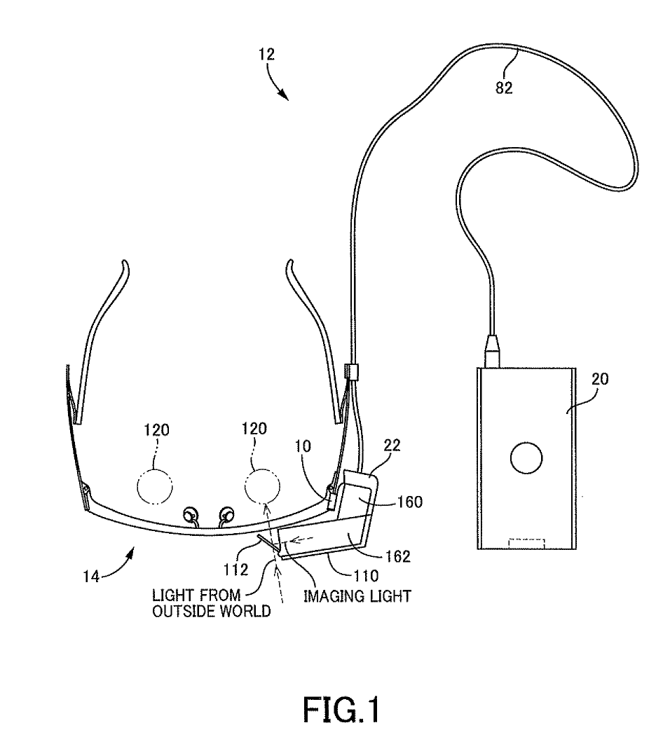

Referring now to FIG. 1, there is illustrated in plan view an attachment device 10 according to an illustrative embodiment of the invention, combined with a head-mounted display device (hereinafter, abbreviated as “HMD”) 12 and an eyeglasses-type frame 14, with these elements mounted on the head of a viewer (i.e., a user or a wearer).

The HMD 12 is mounted on the viewer's head for displaying an image to the viewer by projection of imaging light representative of the image, onto one eye of the viewer. In the present embodiment, the HMD 12 is configured to project the imaging light onto the viewer's one eye, along an optical pathway extending generally on and along a horizontal plane.

The eyeglasses-type frame 14 is worn on the viewer's head for allowing the HMD 12 to be mounted on the viewer's head. More specifically, the eyeglasses-type frame 14, which is similar in shape to conventional eyeglasses, is worn on the viewer's head such that the frame 14 hangs over the viewer's both ears and nose. The eyeglasses-type frame 14 may be exactly in the form of conventional eyeglasses (e.g., eyeglasses for vision correction, sunglasses), or in the form of an exclusive frame for use in the HMD 12 to allow the viewer to perceive or view a displayed image.

The attachment device 10 is used for allowing the HMD 10 to be detachably attached to the eyeglasses-type frame 14.

The HMD 12 is configured to display an image (e.g., a generated or created image, a displayed information view) to the viewer by projection of imaging light onto the viewer's one eye. That is, the HMD 12 is of a monocular type. Further, the HMD 12 is configured to throw a light beam emitted from a light source, to the viewer's retina, and to scan the thrown light on the retina, to thereby allow the viewer to perceive a generated image as a virtual image. That is, the HMD 12 is of a scanning type. Still further, the HMD 12 is configured to allow the viewer to view the displayed image superimposed on a real outside world view. That is, the HMD 12 is of a see-through type.

It is added that, in the present embodiment, the HMD 12 is of a particular, but not exclusive, type as a retinal scanning type, and alternatively the HMD 12 may be, for example, of a spatial light modulation type in which surface light emitted from a light source is spatially modulated using a spatial light modulator such as an LCD, on a per-pixel basis, to thereby project the modulated light onto the viewer's retina.

It is further added that, in the present embodiment, the HMD 12 is of a particular, but not exclusive, type as a see-through type, and alternatively the HMD 12 may be of a closed type in which the viewer views a displayed image only, while being blocked from simultaneously viewing a real outside world view.

The viewer is allowed to use the HMD 12 in an application in which the viewer views only a displayed image (e.g., movie). The viewer is also allowed to use the HMD 12 in an application in which the viewer views the viewer's operation or work in a real outside world, while also viewing a displayed image as a reference image (e.g., an information view), wherein the reference image is displayed to the viewer for providing information required for the viewer to do the work more efficiently.

When the viewer uses the HMD 12 solely for the purpose of viewing a displayed image, the viewer generally desires the displayed image to be located in front of the viewer's one eye (i.e., one of the viewer's both eyes which views the displayed image), which will help the viewer in concentrating the viewer's attention on the displayed image with more ease.

In contrast, when the viewer uses the HMD 12 for the purpose of viewing a reference image, the viewer generally desires the displayed reference-image to be located away from a position in front of the viewer's one eye in a right-and-left direction and/or an up-and-down direction, in order to view the reference image without interference of a real outside world viewing of working operations.

To meet both of the viewer's desires stated above, in the present embodiment, the attachment device 10 is configured to allow the viewer to adjust the position of the HMD 12 relative to the viewer's one eye.

Because the HMD 12 is monocular as described above, it is desirable for the HMD 12 to be attached relative to any one of both eyes of the viewer, and to reproduce a displayed image in a normal operation whether the HMD 12 is attached relative to a right eye or a left eye of the viewer. That is, it is desirable for the same attachment device 10 and the same HMD 12 to be switched between a position that enables image viewing with the viewer's right eye, and a position that enables image viewing with the viewer's left eye.

Additionally, it is also desirable to allow the viewer to shift the attachment device 10 and the HMD 12 between different positions, with the viewer's simplified manipulation required, in order to enhance ease-to-use of the attachment device 10 and the HMD 12.

For fulfillment of all of those desires, the attachment device 10 is configured to allow the viewer to switch the position the attachment device 10 in use between a position that enables image viewing with the viewer's right eye, and a position that enables image viewing with the viewer's left eye, without requiring the viewer to remove or replace any components of the attachment device 10.

The HMD 12, the eyeglasses-type frame 14 and the attachment device 10, although having been described sequentially schematically above, will be described in more detail below.

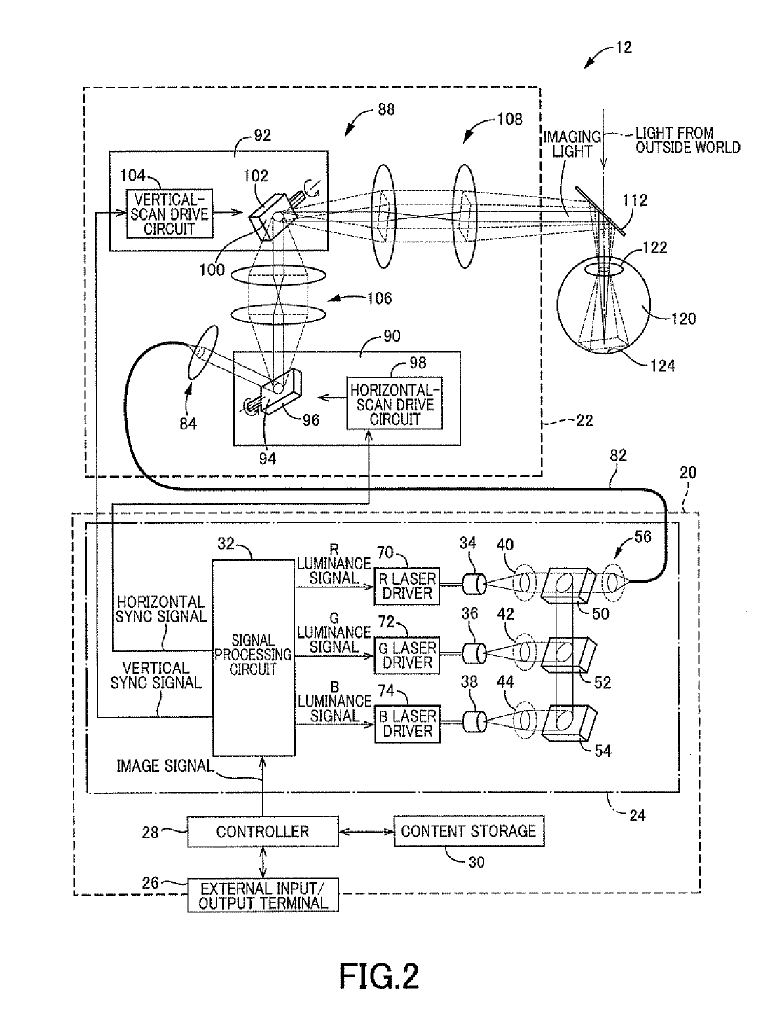

Referring next to FIG. 2, the configuration of the HMD 12 is schematically illustrated in block diagram and optical path diagram.

As illustrated in FIGS. 1 and 2, in the present embodiment, the HMD 12 is configured to include a control unit 20 and a display unit 22 which are physically separate. For the HMD 12, only the display unit 22 is mounted on the viewer's head, while the control unit 20 is, for example, carried by the viewer.

As illustrated in FIG. 2, in the present embodiment, into the control unit 20, a light source 24 is incorporated to generate and emit linear imaging-light (e.g., a multi-color laser beam in an RGB format). Alternatively, the light source 24 may be incorporated into the display unit 22, not the control unit 20, for practicing the invention.

As illustrated in FIG. 2, the control unit 20 includes: an external input/output terminal 26; a controller 28 electrically connected with the external input/output terminal 26; a content storage 30 electrically connected with the controller 28. The content storage 30 may be, for example, in the form of a magnetic storage medium such as a hard disc, an optical storage medium such as a CD-R, or a flash memory.

An external device (not shown) such as a personal computer is electrically connected with the external input/output terminal 26, and image data (e.g., data representative of still picture contents or moving picture contents, such as video data) which is to be reproduced, is inputted from the external device via the external input/output terminal 26.

The controller 28 stores the inputted image data into the content storage 30, if necessary, and, in any event, the controller 28 converts the image data incoming from the external device, into an image signal.

As illustrated in FIG. 2, the light source 24 includes a signal processing circuit 32. The signal processing circuit 32 is configured to generate, from the image signal supplied from the controller 28, an R luminance signal indicative of the luminance of a red(R)-colored laser beam (i.e., a first imaging-light component), a G luminance signal indicative of the luminance of a green (G)-colored laser beam (i.e., a second imaging-light component), and a B luminance signal indicative of the luminance of a blue(B)-colored laser beam (i.e., a third imaging-light component), in order to intensity-modulate the imaging light on a per-imaging-light-component(RGB) basis.

The controller 28 further generates a horizontal sync signal and a vertical sync signal which are reference signals for horizontal scan and vertical scan as described below, respectively.

As described above, the attachment device 10 allows the viewer to shift the attachment device 10 between a position that enables image viewing with the viewer's right eye, and a position that enables image viewing with the viewer's left eye.

Along with that, the signal processing circuit 32 is designed to generate an image signal, such that the orientation of an image reproduced by the image signal, relative to the viewer's one eye, enables the viewer-selected position to view a displayed image, that is, the position of the attachment device 10 when it is worn, in a manual manner that is, in response to the viewer's manipulation of a switch (not shown) or the external device, or in an automated manner (i.e., without any viewer's intervention), that is, in response to a sensor-detected position of the attachment device 10 when it is worn.

In an exemplary implementation, the signal processing circuit 32, provided that a default orientation has been defined as enabling image viewing with the viewer's right eye, is designed to generate an image signal so that an image can be reproduced in the default orientation, and, upon issue of a specific command from the viewer, generate an image signal, so that an image can be reproduced in an orientation 180 degrees inverted from the default orientation.

As illustrated in FIG. 2, the light source 24 includes three lasers 34, 36, 38; three collimating lenses 40, 42, 44; three dichroic mirrors 50, 52, 54, and a combining optical system 56.

The three lasers 34, 36, 38 are an R laser 34 which emits a red-colored laser beam, a G laser 36 which emits a green-colored laser beam, and a B laser 38 which emits a blue-colored laser beam.

Any one of the lasers 34, 36, 38 may be in the form of, for example, a semi-conductor laser or a solid-state laser. It is noted that the semi-conductor laser can modulate the intensity of a laser beam to be emitted from the semi-conductor laser itself, while the solid-state laser cannot modulate the intensity of a laser beam to be emitted from the solid-state laser, and therefore, if each laser 34, 36, 38 is needed to be in the form of the solid-state laser, an intensity modulator is needed to be added.

The three collimating lenses 40, 42, 44 are lenses for collimating tri-color laser beams emitted from the three lasers 34, 36, 38, respectively. The three dichroic mirrors 50, 52, 54, which are wavelength selective, reflect or transmit the tri-color laser beams, to combine the tri-color laser beams emitted from the collimating lenses 40, 42, 44.

The tri-color laser beams are combined by a representative one of the dichroic mirrors 50, 52, 54. In the present embodiment, the dichroic mirror 50 is selected as the representative dichroic mirror. The combined laser beam at the dichroic mirror 50 enters the combining optical system 56 as a composite laser beam (i.e., composite imaging-light) for collection.

As illustrated in FIG. 2, the signal processing circuit 32 is electrically connected with the three lasers 34, 36, 38 through three laser drivers 70, 72, 74, respectively. The signal processing circuit 32 modulates the intensity of a laser beam emitted from each laser 34, 36, 38, through a corresponding one of the laser drivers 70, 72, 74, based on a corresponding one of the R, G and B luminance signals.

As illustrated in FIG. 2, the laser beam (i.e., the composite laser beam, hereinafter referred to simply as “laser beam”) emitted from the combining optical system 56 is transmitted through an optical fiber 82 acting as an optical transfer medium, into a collimating lens 84 within the display unit 22. The laser beam, after collimated by and then emitted from the collimating lens 84, strikes a scanner 88 within the display unit 22.

As illustrated in FIG. 2, the scanner 88 incorporates a horizontal scanning device 90 and a vertical scanning device 92.

The horizontal scanning device 90 includes a resonant deflecting-element 96 and a horizontal-scan drive circuit 98, wherein the deflecting element 96 has a deflecting surface (e.g., a reflective surface) 94 which deflects the incoming laser beam, and which is oscillated for horizontal scan of the deflected laser beam, and the horizontal-scan drive circuit 98 drives the deflecting element 96, based on the horizontal sync signal supplied from the signal processing circuit 32.

Similarly, the vertical scanning device 92 includes a non-resonant deflecting-element 102 and a vertical-scan drive circuit 104, wherein the deflecting element 102 has a deflecting surface (e.g., a reflective surface) 100 which deflects the incoming laser beam, and which is oscillated for vertical scan of the deflected laser beam, and the vertical-scan drive circuit 102 forces the deflecting element 102 to be oscillated, with a sawtooth wave drive signal based on the vertical sync signal supplied from the signal processing circuit 32.

As illustrated in FIG. 2, a laser beam emitted from the horizontal scanning device 90 is converged via a first relay optical system 106, and thereafter, the laser beam enters the vertical scanning device 92.

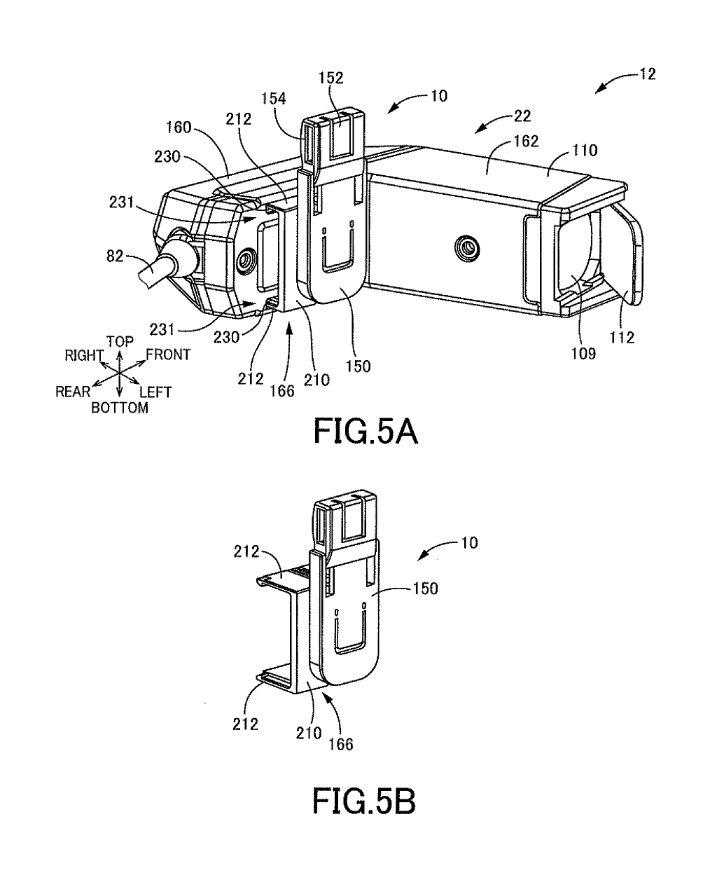

The laser beam scanned by the scanner 88 is converged by a second relay optical system 108, and thereafter exits an exit 109 (see FIG. 5) of the display unit 22. As illustrated in FIG. 1, a half-transparent (or half-silvered) mirror 112 is mounted on a housing 110 of the display unit 22.

As illustrated in FIGS. 1 and 2, the laser beam emitted from the display unit 22 enters the half-transparent mirror 112. The incoming laser beam is reflected from the half-transparent mirror 112, and the reflected laser beam transmits through a pupil 122 of an eyeball 120 of the viewer's one eye, ultimately impinging on a retina 124 of the viewer.

The laser beam incident on the retina 124 is scanned on the retina 124, and as a result, the laser beam is transferred into surface imaging-light. Because of this, the viewer can view a two-dimensional image as a virtual image.

On the viewer's one eye, not only the imaging light reflected from the half-transparent mirror 112 is incident, but also light from a real outside world, passing through the half-transparent mirror 112, is incident. As a result, the viewer can view an image displayed by the imaging light, while viewing a real outside world scene. That is, the viewer can view an image formed by the imaging light superimposed on the real outside world scene.

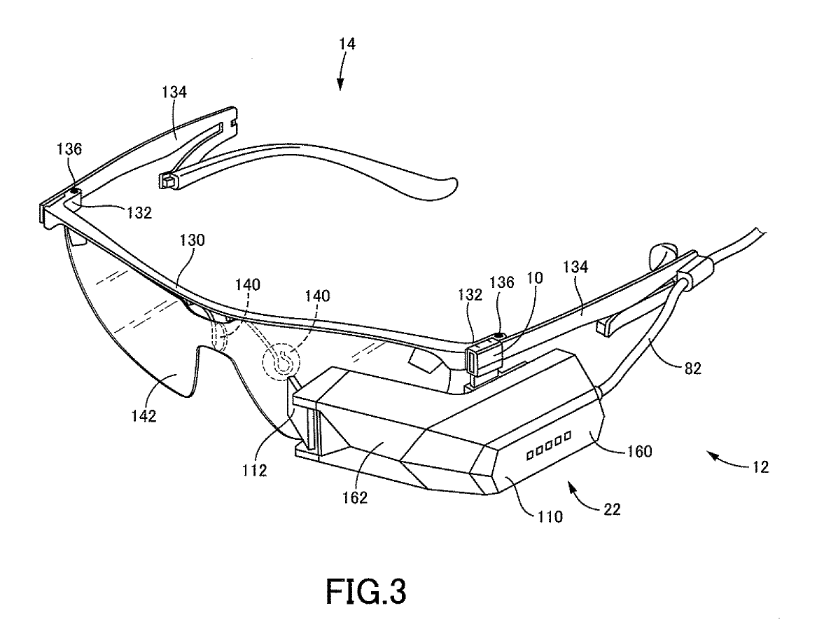

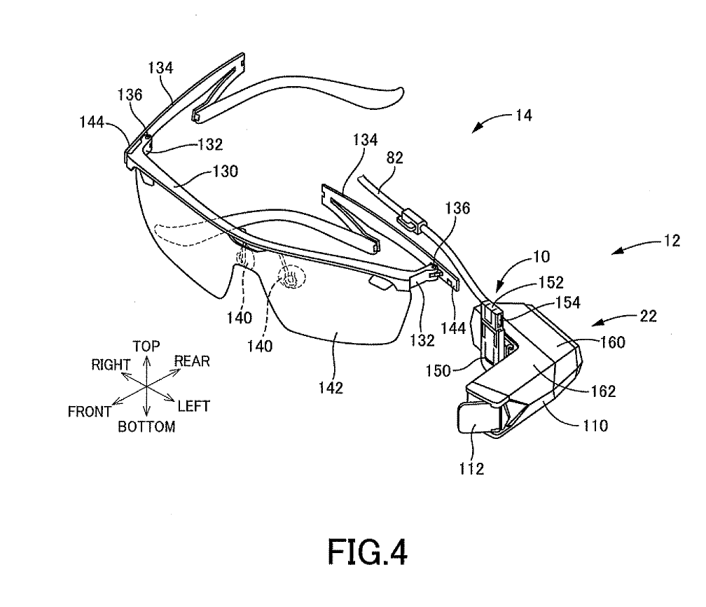

Next, the configuration of the eyeglasses-type frame 14 will be described in more detail by reference to FIGS. 3 and 4.

As illustrated in FIG. 3, the eyeglasses-type frame 14 includes a front portion 130 extending laterally when it is worn on the viewer; a pair of right and left end pieces (i.e., permanent bends) 132, 132; and a pair of right and left temples 134, 134. Base ends of the end pieces 132, 132 are fixedly secured to opposite ends of the front portion 130, respectively, and the temples 134, 134 are coupled to free ends of the end pieces 132, 132, pivotably about hinges 136, 136, such that the temples 134, 134 can be folded horizontally.

The front portion 130 has a pair of nose pads 140, 140 in the intermediate of the front portion 130. The nose pads 140, 140 are in contact with the viewer's nose on both sides, when the eyeglasses-type frame 14 is worn on the viewer.

The front portion 130 further has a protective cover 142. The protective cover 142 is fixedly secured to the front portion 130 so as to extend laterally while covering the viewer's both eyes in front thereof, when the eyeglasses-type frame 14 is worn.

The protective cover 142 is transparent enough to allow outgoing light from the display unit 22 to pass through the protective cover 142. The protective cover 142 blocks the display unit 22 from contacting the viewer's eyes unintendedly.

In FIG. 4, the temples 134, 134 are illustrated such that one of them which is located on a left-hand side with regard to the viewer is in a folded position, while the other which is located on a right-hand side with regard to the viewer is in an unfolded position.

As is evident from FIG. 4, each temple 134 has its extension 144 which extends from a connection of each temple 134 with the corresponding end piece 132, at which the corresponding hinge 136 is located, in a forward direction with respect to the viewer. The extension 144 is inserted into an attachment hole 154 of an attachment portion 152 of a main body 150 of the attachment device 10, to thereby allow the attachment device 10 to be detachably mounted on the eyeglasses-type frame 14.

When the eyeglasses-type mirror 14 is worn on the viewer's head, that is, when the temples 134, 134 are unfolded with regard to the end pieces 132, 132, the attachment portion 152 is interposed between the corresponding extension 144 and the corresponding end piece 132. This arrangement allows the display unit 22 to be firmly held by the eyeglasses-type frame 14, without unintended removal and drop of the display unit 22.

In an exemplary implementation illustrated in FIG. 4, the attachment device 10 is mounted on the extension 149 of the left temple 134, to thereby allow the display unit 22 to be placed in a position (i.e., a left-hand side attachment position) that enables image viewing with the viewer's left eye.

If, however, the attachment device 10 is mounted on the extension 144 of the right temple 134, to thereby allow the display unit 22 to be placed in a position (i.e., a right-hand side attachment position) that enables image viewing with the viewer's right eye.

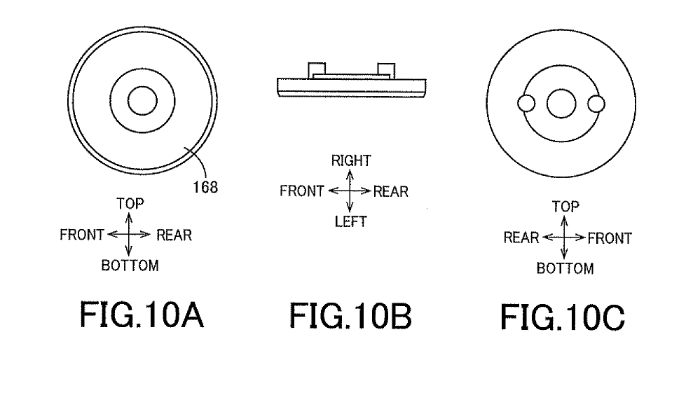

Next, the configuration and operation of the attachment device 10 will be described in more detail by reference to FIGS. 3-15.

In FIG. 5A, the entire exterior of the attachment device 10 is illustrated in combination with the display unit 22 of the HMD12, with the attachment device 10 mounted on the housing 110, in perspective view. In FIG. 5B, only the attachment device 10 is illustrated in perspective view.

The display unit 22 is generally L-shaped in play view, when it is worn on the viewer's head. More specifically, as illustrated in FIG. 1, in the display unit 22, a first portion 160 extending in a back-and-forth direction, and a second portion 162 extending laterally, are interconnected so as to be generally L-shaped in plan view.

As illustrated in FIG. 3, the first portion 160 is located outside the corresponding temple 134, while the second portion 162 is located in front of the corresponding temple 134.

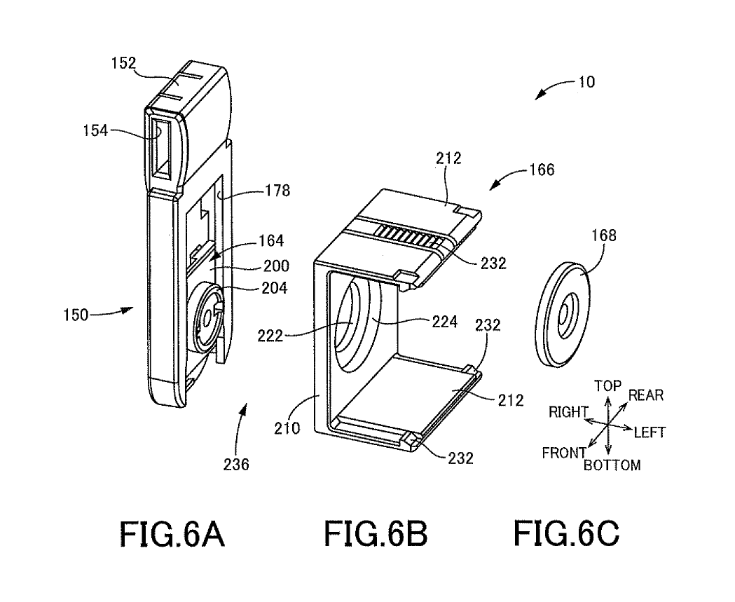

As illustrated in FIG. 5A, the main body 150 is mounted on an inner side-face of the first portion 160, which faces the corresponding temple 134. The main body 150 is mounted on the first portion 160 via a linearly-displaceable member 164 (see FIG. 6A) and a movable member 166.

In FIG. 6, the attachment device 10 is illustrated in exploded perspective view.

As illustrated in FIG. 6, the linearly-displaceable member 164 is mated with (or fitted in) the main body 150 so as to be linearly displaceable (i.e., movable in an up-and-down direction, in FIG. 6). The movable member 166 is mated with (or fitted in) the linearly-displaceable member 164 so as to be rotatable (i.e., rotatable about a rotation axis extending in a right-and-left direction, in FIG. 6). The movable member 166 is held by the linearly-displaceable member 164 such that a retainer 168 blocks the movable member 166 from removing from the linearly-displaceable member 164m, and such that the movable member 166 is rotatable about the rotation axis.

In FIG. 6A, the main body 150 is illustrated when the linearly-displaceable member 164 is attached thereto, in perspective view. In FIG. 68, the movable member 166 is illustrated in perspective view. In FIG. 6C, the retainer 168 is illustrated in perspective view.

The main body 150, the linearly-displaceable member 164, the movable member 166 and the retainer 168 together constitute the attachment device 10.

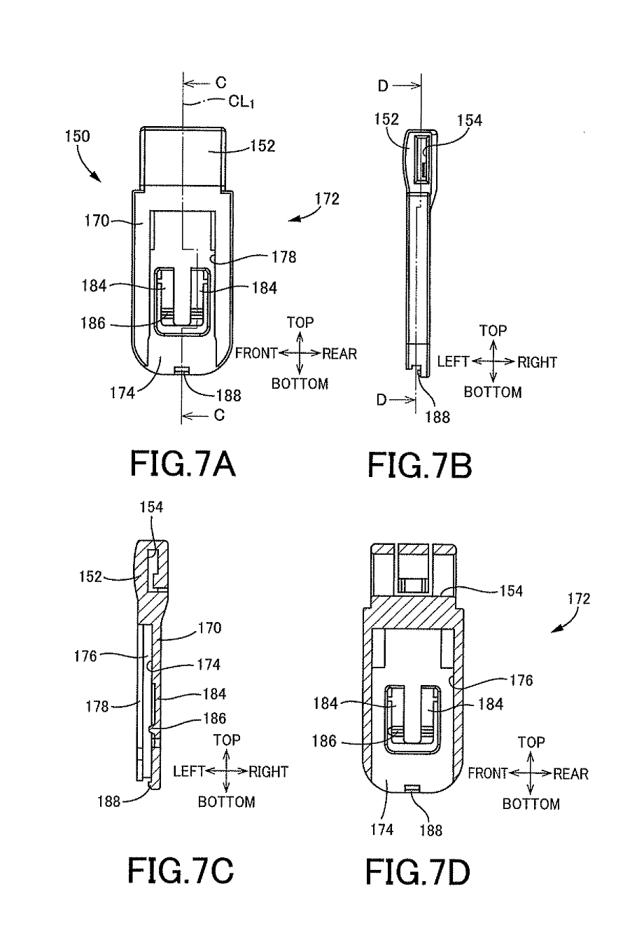

As illustrated in FIG. 7A, the main body 150 has a centerline CL1. The main body 150 extends along the centerline CL1, and is symmetrically shaped with regard to the centerline CL1.

The main body 150 includes the aforementioned attachment portion 152 and a connection portion 170 in a linear array along the centerline CL1. The connection portion 170 has an engagement groove 172 extending along the centerline CL1, with an inverted T-shaped cross-section.

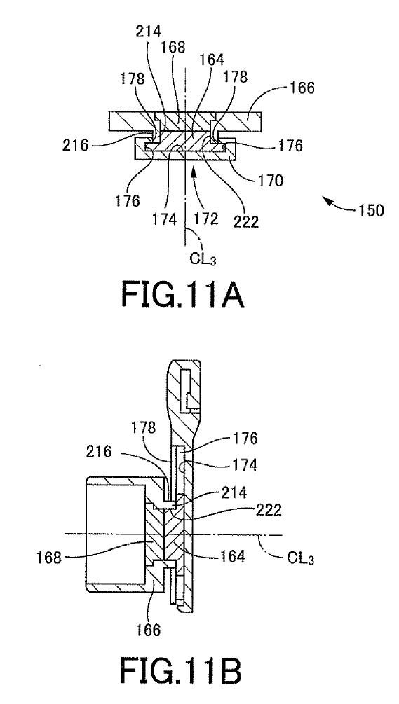

In FIG. 11A, the engagement groove 172 is illustrated in traverse sectional view. The engagement groove 172 includes a bottom-wall surface 174; a pair of first side-wall surfaces 176, 176 proximate to the bottom-wall surface 174; and a pair of second side-wall surfaces 178, 178 proximate to an opening of the engagement groove 172. The distance (i.e., the lateral distance) between the first side-wall surfaces 176, 176 is larger than the distance between the second side-wall surfaces 178, 178.

Both of the first side-wall surfaces 176, 176 form a straight line over the total length, while the second side-wall surfaces 178, 178 have distances between facing surfaces which vary along the length. The configuration and functions of the second side-wall surfaces 178, 178 will be elaborated below.

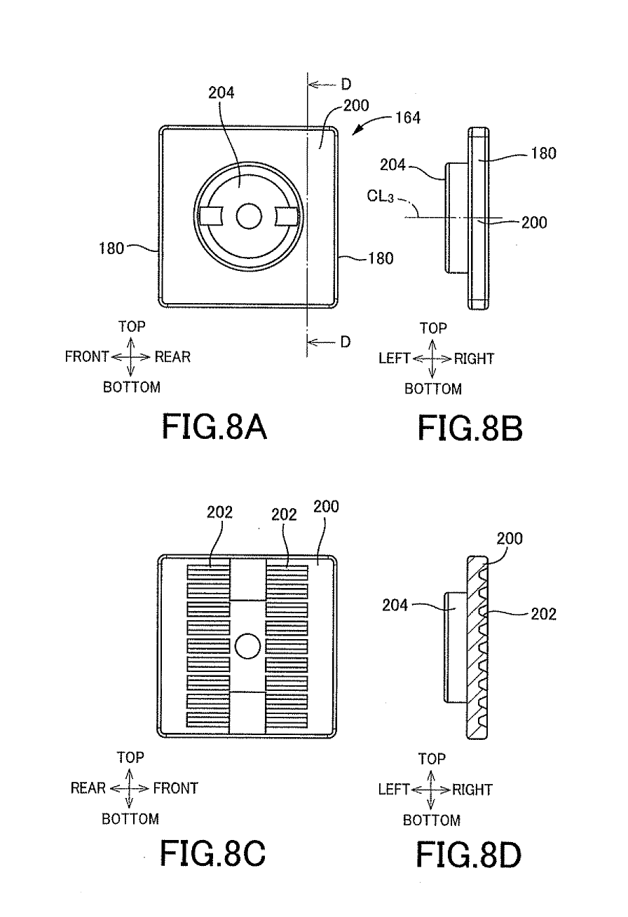

The linearly-displaceable member 164 is fitted in the main body 150, such that opposite side faces 180, 180 of the linearly-displaceable member 164 (see FIG. 8A) are in slidable contact with the first side-wall surfaces 176, 176, respectively. As a result, the linearly-displaceable member 169 is linearly displaceable relative to the main body 150, in a direction parallel to the centerline CL1 of the main body 150 (i.e., an up-and-down direction, in FIG. 6A).

As illustrated in FIGS. 7A and 7C, the main body 150 further includes a cantilevered spring piece 184 (i.e., two pieces in total, in the present embodiment), and a free end of the spring piece 184 has a projection 186. Its function will be described below.

The main body 150 further includes a stop 188. The stop 188 has the function of blocking the linearly-displaceable member 164 from disconnecting from the main body 150.

As illustrated in FIG. 8A, the linearly-displaceable member 164 has a base plate 200 generally rectangular-shaped which has both side faces 180, 180 as described above.

As illustrated in FIGS. 8B and 8C, the base plate 200 has a linear array of a plurality of parallel grooves 202 (e.g., two groove arrays, in the present embodiment) formed on a front face of the base plate 200. The projection 186 is elastically mated with one of the grooves 202, with the linearly-displaceable member 164 being fitted in the main body 150.

In the present embodiment, the grooves 202 and the projection 186 together constitute a detent mechanism for allowing the linearly-displaceable member 164 to be held at an arbitrary one of possible linear positions, relative to the main body 150.

As illustrated in FIGS. 8A and 8B, the base plate 200 has an engagement portion 204 with a circular cross section, formed on a back face of the base plate 200. The engagement portion 204 has a centerline (or a center axis) CL3.

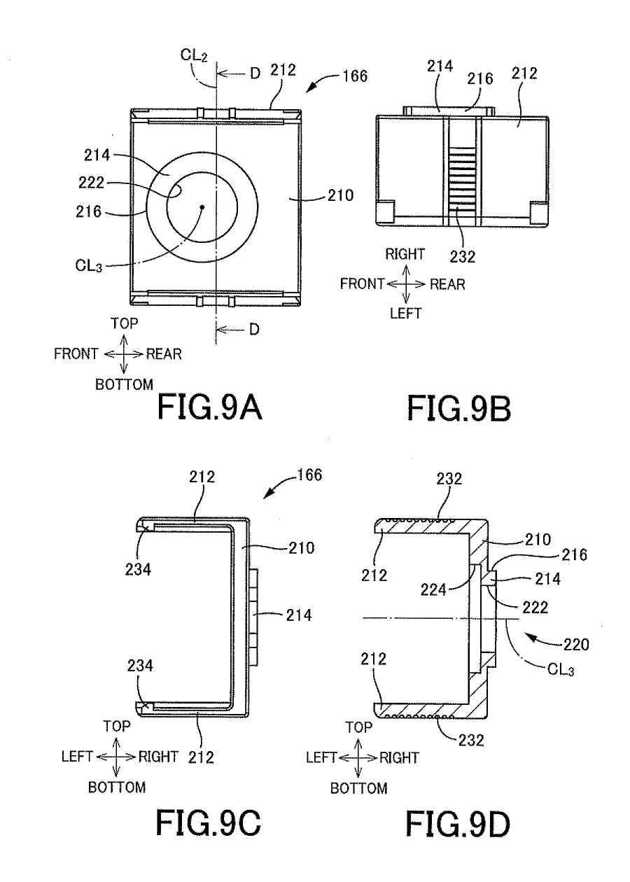

As illustrated in FIG. 9A, the movable member 166 has a centerline CL2. In addition, as illustrated in FIG. 9C, the movable member 166 has a shape extending along a straight line with a generally U-shaped cross section. More specifically, the movable member 166 includes a base plate 210, and a pair of coupling plates 212, 212 coextending from opposite ends of the base plate 210, in the same direction, such that each coupling plate 212, 212 is oriented at right angles to the surface of the base plate 210.

As illustrated in FIGS. 9A, 9B, 9C and 9D, an engagement protrusion 214 is raised from one of opposite faces of the base plate 210 which is opposite to the other face from which the coupling plates 212, 212 project. The engagement protrusion 214 has a centerline (for ease of description, it is, hereinafter, referred to as “centerline CL3,” because it is coincident with the centerline CL3 of the linearly-displaceable member 164) and a circular cross section coaxial with the centerline CL3. The engagement protrusion 214 has an outer circumference in the shape of an imperfect circle which is deviated from a perfect circle. The configuration and functions of the outer circumference 216 will be elaborated below.

As illustrated in FIG. 9D, a stepped hole 220 is formed through the thickness of the base plate 210. The stepped hole 220 has a linear array of a small diameter hole 222 and a large diameter hole 224 which are coaxial with the centerline CL3. An outer circumference of the engagement portion 204 of the linearly-displaceable member 164 is slidably rotatably fitted in the small diameter hole 222, to thereby allow the base plate 210 of the movable member 166 to be rotatably mounted on the linearly-displaceable member 164.

The retainer 168 is slidably rotatably fitted in the large diameter hole 224. The retainer 168 is fixedly secured to a leading face of the engagement portion 204 in a non-detachable manner. As a result, the retainer 168 blocks the movable member 166 from removing from the linearly-displaceable member 164 axially.

The retainer 168 provides resistant to slide motion between one surface of the retainer 168 and a shoulder face of the stepped hole 220, and to slide motion between the leading face of the engagement protrusion 214 and one surface of the linearly-displaceable member 164. The provided resistance allows the movable member 166 to be held at an arbitrary one of possible angular positions.

In the present embodiment, the movable member 166 is linearly displaced, together with the linearly-displaceable member 164, relative to the main body 150. In addition, the movable member 166 is mounted on the linearly-displaceable member 164 rotative relative to the linearly-displaceable member 164 about a rotation axis fixed to the linearly-displaceable member 164 (for ease of description, it is hereinafter referred to as “rotation axis CL3,” because it is coincident with the centerline CL3 depicted in FIG. 8B).

As described above, the movable member 166 is linearly displaced, together with the linearly-displaceable member 164, relative to the main body 150, and therefore, the rotation axis CL3 of the movable member 166 is linearly displaced together with the movable member 166, that is, together with the linearly-displaceable member 164, in synchronization with linear displacement of the movable member 166 relative of the main body 150.

In the present embodiment, the attachment device 10 is mounted on the main body 150 using the linearly-displaceable member 164, but alternatively the attachment device 10 may be directly mounted on the main body 150 for practicing the invention.

The movable member 166 allows the viewer to linearly displace the HMD 12 relative to the main body 150, with the attachment device 10 mounted on the eyeglasses-type frame 14, to thereby allow the viewer to adjust the position of the HMD 12 in an up-and-down direction Y, relative to the viewer's one eye.

The movable member 166 further allows the viewer to angularly displace the HMD 12 relative to the main body 150, to thereby allow the viewer to adjust the angle θ of the HMD 12 in a vertical plane, relative to the viewer's one eye.

As illustrated in FIG. 5A, the coupling plates 212, 212 of the movable member 166 are inserted into a pair of elongate holes 230, 230 formed in the housing 110 of the display unit 22 of the HMD 12, in a slidable and linearly displaceable state.

The coupling plates 212, 212 allows the viewer to linearly displace the HMD 12 relative to the main body 15, with the attachment device 10 mounted on the eyeglasses-type frame 14, to thereby allow the viewer to adjust the position of the HMD 12 in a right-and-left direction X, relative to the viewer's one eye.

In other words, in the present embodiment, the coupling plates 212, 212 and the elongate holes 230, 230 together constitute a position adjuster 231 which enables adjustment of the position of the HMD 12 in the right-and-left direction X relative to the viewer's one eye.

As illustrated in FIGS. 9B and 9C, an outer side-face of each coupling plate 212, 212 has a linear array of parallel grooves 232 formed on the outer side-face. The housing 110 of the display unit 22 includes a cantilevered spring piece (not shown) located in the vicinity of each elongate hole 230, 230, and a free end of the spring piece has a projection (not shown). The projection is elastically mated with one of the grooves 232, with each coupling plate 212, 212 inserted in the corresponding elongate hole 230. This allows the movable member 166 to be held at an arbitrary one of possible linear positions, relative to the housing 110

In other words, the grooves 232 and the spring piece together constitute a detent mechanism for allowing the movable member 166 to be held at an arbitrary one of possible linear positions.

As illustrated in FIG. 9C, a leading end of each coupling plate 212 has a stop 234 formed thereon. The stop 234 blocks the corresponding coupling plate 212 from removing from the corresponding elongate hole 230, after insertion thereinto.

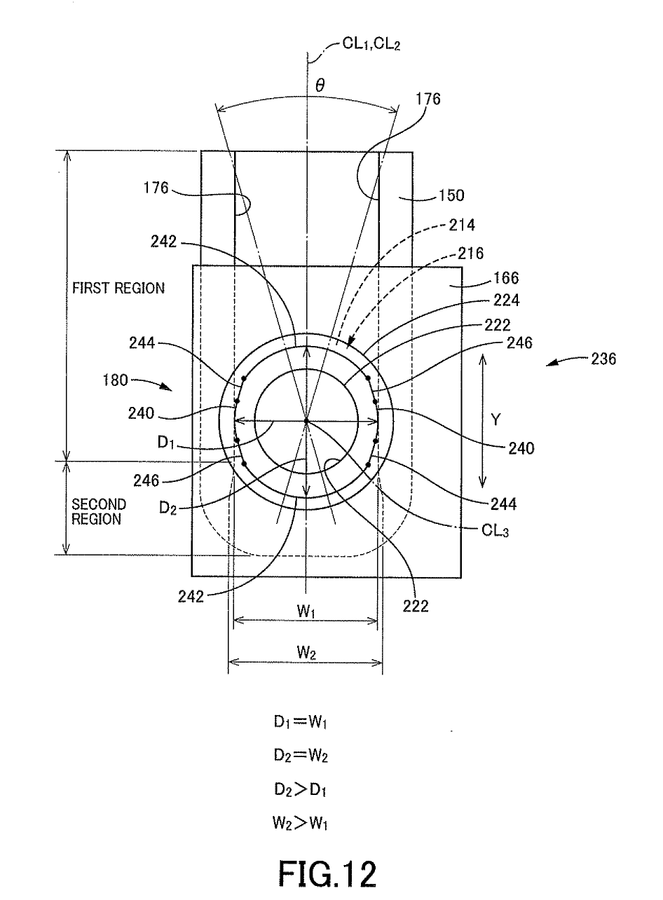

As illustrated in FIG. 12, in the present embodiment, the second side-wall surfaces 178, 178 of the main body 150 and the outer circumference 216 of the engagement protrusion 214 of the movable member 160 together constitute a mode changer 236.

The mode changer 236 is configured to selectively change a mode in (or a maximum angular range within) which the movable member 166 can be angularly displaced relative to the main body 150. The mode changer 236 is configured to selectively change the angular displacement mode of the movable member 166 relative to the main body 150, in a mechanically synchronized manner with the linear displacement of the movable member 166 relative to the main body 150.

More specifically, the mode changer 236 changes the mode between a small-rotation-angle mode in which the movable member 166 is allowed to rotate over (i.e., through or within a range of) an angle smaller than 180 degrees, and a large-rotation-angle mode in which the movable member 166 is allowed to rotate over an angle equal to or larger than 180 degrees, in a mechanically synchronized manner with the linear displacement of the movable member 166 relative to the main body 150.

As illustrated in FIG. 12, the movable member 166 is placed in the viewer-selected one of first and second regions which together form a linear array along a direction of the linear displacement of the movable member 166 relative to the main body 150. The first region is defined to include the uppermost one of possible linear positions of the movable member 166 relative to the main body 150, while the second region is defined to include the lowermost one of possible linear positions of the movable member 166 relative to the main body 150.

The mode changer 236 selects the small-rotation-angle mode when the movable member 166 is located within the first region, while it selects the large-rotation-angle mode when the movable member 166 is located within the second region.

In the present embodiment, the small-rotation-angle mode refers to a mode in which a maximum angular range of the relative angular displacement of the movable member 166 is limited, while the large-rotation-angle mode refers to a mode in which a maximum angular range of the relative angular displacement of the movable member 166 is not limited.

When the large-rotation-angle mode is selected, the viewer is allowed to rotate the movable member 166 in 180-degree angles or more, relative to the main body 150. Because of this, the viewer is allowed to shift the same display unit 22 between a position enabling image viewing with the viewer's left eye, and a position enabling image viewing with the viewer's right eye, without a need of removing the movable member 166 from the main body 150.

Within the first region, the second side-wall surfaces 178, 178 face each other over a distance W1 (i.e., a gap between facing surfaces or a wall-to-wall distance), while, within the second region, the second side-wall surfaces 178, 178 face each other over a distance W2 which is larger than the distance W1. Within the second region, there is a gradual-change sub-region in the vicinity of the first region, in which the distance W2 (i.e., a gap between the second side-wall surfaces 178, 178) gradually varies from a value equal to the distance W1 to the maximum value of the distance W.”

The outer circumference 216 of the engagement protrusion 214 is locally or in part brought into contact with the thus-configured second side-wall surfaces 178, 178, in a point or line contact manner, selectively.

As illustrated in FIG. 12, the outer circumference 216 is defined by a single perfect circle about the centerline CL3, but a combination of two kinds of segments which are coaxial but different in diameter. More specifically, the outer circumference 216 is defined by a combined circle made of a pair of first arc segments having a diameter D1, and a pair of second arc segments having a diameter D2 larger than the diameter D1.

The outer circumference 216 has a first pair of straight segments 244, 244 and a second pair of straight segments 246, 246 between the first arc segments 240, 240 and the second arc segments 242, 242. Every pair of straight segments 244, 244, 246, 246 is in the form of a pair of two parallel straight segments. Between one first arc segment 240 and one second arc segment 242 which are adjacent to each other, there are one straight segment 249 and one straight segment 246, which together couple one end of the one first arc segment 240 and one end of the one second arc segment 242.

The diameter D1 is equal to the distance W1, while the diameter D2 is equal to the distance W2. As a result, when the first arc segments 240, 240 are in point contact with the second side-wall surfaces 178, 178 within the first region of an entire area (i.e., the entire length), the movable member 166 rotates smoothly relative to the main body 150.

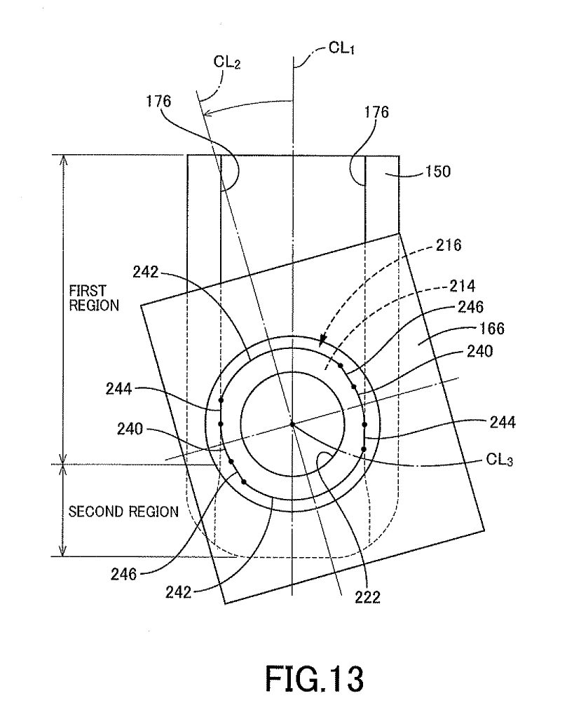

As illustrated in FIG. 13, further rotation of the movable member 166 in the same direction as before brings one pair of the first pair of straight segments 244, 244 and the second pair of straight segments 246, 246 into line contact with the second side-wall surfaces 178, 178 within the first region of the entire length. In this regard, a distance between the first pair of straight segments 244, 244 and a distance between the second pair of straight segments 246, 246 are each equal to the diameter D1, therefore, the distance D1.

As a result, when any one of the first and second pairs of straight segments 244, 244, 246, 246 is bought into line contact with the second side-wall surfaces 178, 178 within the first region of the entire length, further rotation of the movable member 166 in the same direction as before becomes inhibited. The reason is that, as the movable member 166 rotates in the same direction, a distance of each point on each straight segment 244, 246 from the centerline CL3 increases from a value equal to the distance D1 toward a value equal to the distance D2.

Therefore, in this state, a corresponding one of the first and second pairs of straight segments 244, 244, 246, 246 acts as a stop for limiting the maximum angle of the movable member 166 relative to the main body 150.

It follows that FIG. 13 illustrates the movable member 166 when it is inclined in one direction from the main body 150, at the maximum angle (i.e., a maximum inclination angle) from the main body 150.

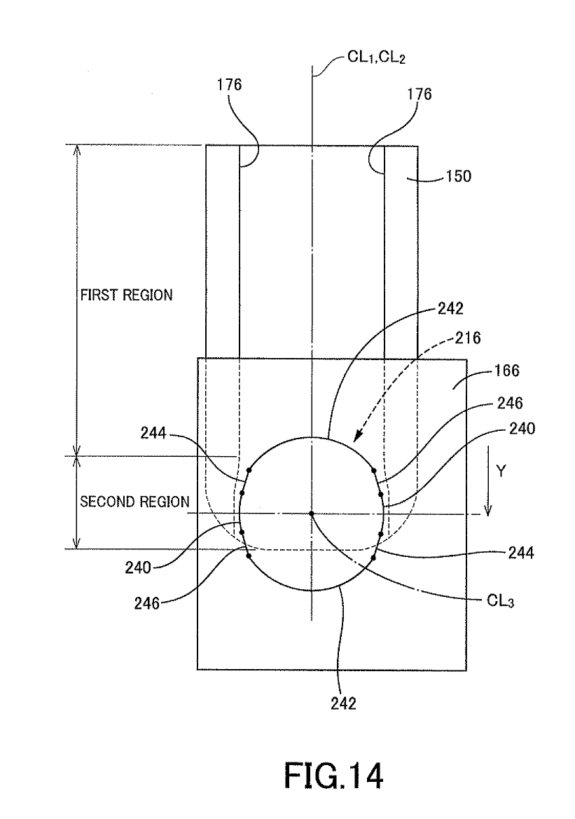

As illustrated in FIG. 14, downward movement of the movable member 166 relative to the main body 150 eventually causes the outer circumference 216 to enter the second region of the entire length of the second side-wall surfaces 178, 178. In this state, simultaneous point contacting of the first arc segments 240, 240 with the respective second side-wall surfaces 178, 178 is not achieved, and none of the first and second pairs of straight segments 244, 244, 246, 246 is brought into point contact with the second side-wall surfaces 178, 178.

Therefore, when the outer circumference 216 is located within the second region of the entire length of the second side-wall surfaces 178, 178, the movable member 166 is allowed to rotate freely relative to the main body 150, beyond the maximum inclination angle.

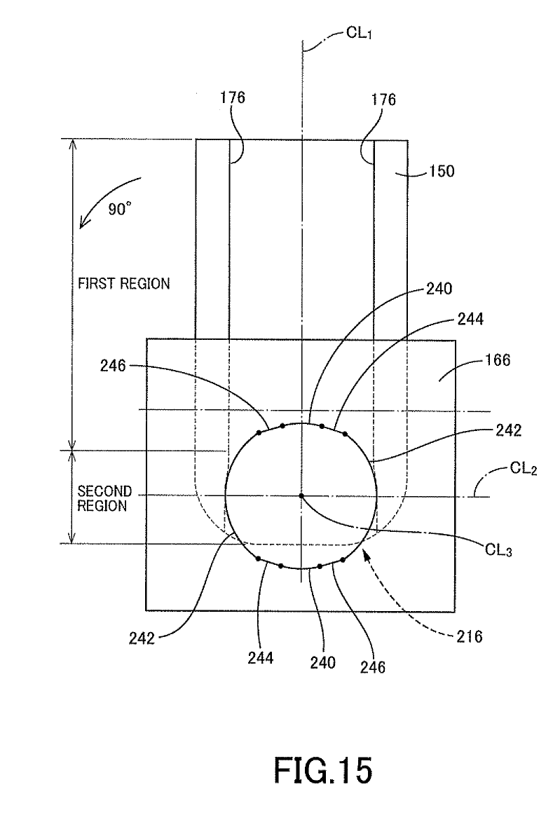

As illustrated in FIG. 15, further rotation of the movable member 166 in the same direction as before eventual ly brings the second arc segments 242, 242 into point contact with facing portions of the second side-wall surfaces 178, 178 which are spaced apart the distance D2 and located within the second region of the total length. In this state, the movable member 166 is allowed to slidably rotate freely relative to the main body 150, beyond the maximum inclination angle.

As will be evident from the foregoing, in the present embodiment, when the movable member 166 is located within a normal linear displacement zone, that is, the first region, any one of the first and second pairs of straight segments 244, 244, 246, 246 is in line contact with the second side-wall surfaces 178, 178, with the capability of acting as a stop, which limits a maximum angle through which the movable member 166 can rotate relative to the main body 150.

Therefore, when the movable member 166 is within the normal linear displacement zone, the movable member 166 is blocked from rotating relative to the main body 150, through an angle larger than required.

As a result, in the present embodiment, an extra motion of the movable member 166 is prevented, resulting in enhancement of the ease-to-use of the attachment device 10.

Further, once the movable member 166 has been linearly displaced relative to the main body 150 beyond the normal linear displacement zone and has entered the second region, a clearance is created between any one of the first and second pairs of straight segments 244, 244, 246, 246 and the second side-wall surfaces 178, 178, which disables the movable member 166 to act as a stop.

Therefore, the movable member 166 becomes able to rotate freely relative to the man body 150 beyond the maximum inclination angle, allowing the viewer to switch the position of the HMD 12 in use from a position suitable for the viewer's left eye to a position suitable for the viewer's right eye, or inversely, from a position suitable for the viewer's right eye to a position suitable for the viewer's left eye, without requiring the viewer to replace or remove any one of components of the attachment device 10.

As a result, the present embodiment would enhance the ease of switchability of the HMD 12 between right and left positions, therefore, the ease-to-use of the HMD 12.

As will be apparent from the foregoing, in the present embodiment, the mode changer 236 selectively changes an angular displacement mode of the movable member 166 relative to the main body 150 (i.e., a maximum angular range within which the movable member 166 can rotate relative to the main body 150) between the small-rotation-angle mode in which the movable member 166 can rotate through an angle smaller than 180 degrees, and the large-rotation-angle mode in which the movable member 166 can rotate through an angle equal to or larger than 180 degrees, in a mechanically synchronized manner with the linear displacement of the movable member 166 relative to the main body 150.

As will be readily understood from the above, in the present embodiment, the connection portion 170 constitutes an example of the “first engagement portion,” the second side-wall surfaces 178, 178 together constitute an example of the “first engagement surface,” the engagement protrusion 214 constitutes an example of the “second engagement portion,” and the outer circumference 216 constitutes an example of the “second engagement surface.”

Reference throughout the specification to “one embodiment” or “an embodiment” means that a particular feature, structure, or characteristic described in connection with the embodiment is included in at least one embodiment of the present invention.

Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. An HMD attachment device for attaching a head-mounted display device (HMD) to an eyeglasses-type frame worn on a head of a viewer, wherein the HMD is mounted on the head of the viewer for projecting imaging light representative of an image onto one eye of the viewer, to thereby display the image to the viewer, the HMD attachment device comprising:
a main body detachably attached to the eyeglasses-type frame;
a movable member disposed between the main body and the display device, wherein the movable member is angularly displaceable about a rotation axis, relative to the main body, the movable member is linearly displaceable relative to the main body, and the movable member is held at a selected one of possible angular positions and a selected one of possible linear positions; and
a mode changer configured to selectively change a mode in which the movable member is angularly displaced relative to the main body, between a small-rotation-angle mode which enables the movable member to be angularly displaced through an angle smaller than 180 degrees, and a large-rotation-angle mode which enables the movable member to be angularly displaced through an angle equal to or larger than 180 degrees, wherein the mode change is in a mechanically synchronized manner with a relative linear displacement of the movable member to the main body.

2. The HMD attachment device according to claim 1, wherein the movable member is selectively switched by the viewer, between a first region and a second region which are in a linear array along a direction of the relative linear displacement, and
the mode changer selects the small-rotation-angle mode when the movable member is located in the first region, and selects the large-rotation-angle mode when the movable member is located in the second region.

3. The HMD attachment device according to claim 1, wherein the small-rotation-angle mode is a mode in which the relative angular displacement of the movable member is limited, while the large-rotation-angle mode is a mode in which the relative angular displacement of the movable member is not limited.

4. The HMD attachment device according to claim 1, wherein the rotation axis is linearly displaced with the movable member, in synchronization with a linear displacement of the movable member relative to the main body.

5. The HMD attachment device according to claim 4, further comprising a linearly-displaceable member which is linearly displaceable relative to the main body, in a direction parallel to a centerline of the main body, and which is held at a selected on of possible linear positions,
wherein the movable member is attached to the linearly-displaceable member, such that the movable member is not linearly displaceable relative to the linearly-displaceable member, and such that the movable member is angularly displaceable about the rotation axis, relative to the linearly-displaceable member, to thereby cause the rotation axis to be linearly displaced with the linearly-displaceable member.

6. The HMD attachment device according to claim 1, wherein the movable member allows the viewer to adjust a position of the display device in an up-and-down direction, relative to the one eye of the viewer, by the viewer's manipulation of linearly displacing the display device relative to the main body, with the HMD attachment device mounted on the eyeglasses-type frame, and
the movable member further allows the viewer to adjust an angular position of the display device within in a vertical plane, relative to the one eye of the viewer, by the viewer's manipulation of angularly displacing the display device relative to the main body.

7. The HMD attachment device according to claim 1, wherein the movable member is attached to the display device via a position adjuster,
the position adjuster is configured to allow the viewer to linearly displace the display device relative to the main body, in a direction crossing the centerline of the main body, and
the position adjuster is further configured to retain the display device at a selected one of the possible linear positions.

8. The HMD attachment device according to claim 7, wherein the position adjuster al lows the viewer to adjust a position of the display device in a right-and-left direction, relative to the one eye of the viewer, by the viewer's manipulation of linearly displacing the display device relative to the main body, with the HMD attachment device mounted on the eyeglasses-type frame.

9. The HMD attachment device according to claim 1, wherein the mode changer is configured to include:
a first engagement portion formed in the main body, wherein the first engagement portion has a first engagement surface which extends along a centerline of the main body, locations are arrayed on and along the first engagement surface, the locations have respective lateral distances from the centerline of the main body, and the lateral distances vary at least in part between corresponding respective linear positions arrayed on and along the centerline of the main body; and
a second engagement portion formed in the main body for allowing for mechanical engagement with the first engagement portion, wherein the second engagement portion has a second engagement surface which extends generally along at least a part of a circle about a center point identified by viewing the rotation axis in a direction thereof, locations are arrayed on and along the second engagement surface, the locations have respective radial distances from the center point, and the radial distances vary at least in part between corresponding respective angular positions arrayed on and along the second engagement surface.

10. The HMD attachment device according to claim 1, wherein the mode changer is configured to include:
a groove formed in the main body so as to extend along a centerline of the main body, wherein the groove has a pair of facing side-wall surfaces which are symmetric with respect to the centerline of the main body, the pair of side-wall surfaces are spaced wall-to-wall distances apart at respective longitudinal positions arrayed on and along the centerline of the main body, and the wall-to-wall distances vary at least in part between corresponding respective longitudinal positions, and
an engagement protrusion formed in the main body so as to have a center axis which is coaxial with the rotation axis, wherein the engagement protrusion has a cross section taken on a plane perpendicular to the center axis of the engagement protrusion, the cross section has an outer circumference generally in the form of a circle about the center axis, the outer circumference is mechanically engaged in part with the pair of side-wall surfaces of the groove, locations are arrayed on and along the outer circumference, the locations have corresponding respective radial distances from the center axis, and the radial distances vary at least in part between corresponding respective angular positions.

11. The HMD attachment device according to claim 10, wherein the groove has first and second zones which are in a linear array along the centerline of the main body and which located at respective different positions,
the wall-to-wall distances within the first zone are smaller than those within the second zone,
the outer circumference has a pair of first arc segments, and a plurality of straight segments each of which extends from one of both ends of a corresponding one of the pair of first arc segments and which is tangential to the corresponding first arc segment at the one end,
the pair of first arc segments, when the engagement protrusion is located between the pair of side-wall surfaces within the first zone, is allowed to be brought into an engagement state in which the pair of first arc segments are mechanically engaged with the pair of side-wall surfaces within the first zone, and is allowed to be slidably rotated relative to the pair of side-wall surfaces, in the engagement state,
the straight segments, upon entry from a state in which the pair of first arc segments are mechanically engaged with the pair of side-wall surfaces within the first zone, into a state in which the engagement protrusion is slidably rotated relative to the straight segments, in a direction allowing the pair of first arc segments to move toward the straight segments, is brought into abutment with the pair of side-wall surfaces within the first zone, to thereby allow the engagement protrusion to act as a stop which blocks the engagement protrusion from further slide rotation in the same direction, to thereby achieve the small-rotation-angle mode of the movable member, and
the straight segments, when the engagement protrusion is located between the pair of side-wall surfaces within the second zone, does not act as the stop, to thereby achieve the large-rotation-angle mode of the movable member.

12. The HMD attachment device according to claim 11, wherein the outer circumference further includes a pair of second arc segments on a circle having a diameter larger than a diameter of a circle on which the pair of first arc segments, and
the pair of second arc segments, when the engagement protrusion is located between the pair of side-wall surfaces within the second zone, is mechanically engaged with the pair of side-wall surfaces within the second zone, and is slidably rotated relative to the pair of side-wall surfaces, to thereby achieve the large-rotation-angle mode of the movable member.

13. The HMD attachment device according to claim 1, wherein the main body has a shape symmetric with regard to a centerline of the main body.

14. The HMD attachment device according to claim 1, wherein the display device is configured to project the imaging light onto the one eye of the viewer, along an optical pathway extending generally on and along a horizontal plane.
